(19) United States
(12) Patent Application Publication
(10) Pub. No.: US 2005/0108946 A1
(43) Pub. Date: May 26, 2005

(54) Finger guard

(76) Inventor: Nissim Shaharbani, Kfar Sava (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 11/016,821

(22) Filed: Dec. 21, 2004

Related U.S. Application Data
(63) Continuation-in-part of application No. 10/449,673, filed on Jun. 2, 2003, now Pat. No. 6,832,450.

(51) Int. Cl. E06B 7/16

(52) U.S. Cl. 49/383

(57) ABSTRACT

A finger guard including a flexible member including a plurality of folds and two opposite edge portions, the flexible member having a folded configuration and a spread configuration, and a pair of attachment members, one being securable to a door and the other being securable to a door jamb, each of the attachment members including a receiving portion for receiving therein one of the edge portions of the flexible member, wherein folds at a center of the finger guard, called central folds, protrude farther out than folds at sides of the finger guard.

### CROSS REFERENCE TO OTHER APPLICATIONS

This application is a continuation-in-part of U.S. patent application Ser. No. 10/449,673, filed Jun. 2, 2003, now U.S. Pat. No. 6,832,450, issued Dec. 21, 2004, the disclosure of which is incorporated herein, and claims priority therefrom.

### FIELD OF THE INVENTION

The present invention relates generally to door guards and, more specifically, to door guards to prevent persons from getting their fingers pinched between the door and the doorjamb.

### BACKGROUND OF THE INVENTION

One of the problems with hinged doors is that, as the door is swung open, a gap is formed between the edge of the door and the door jamb. When the door is closed, the gap closes as the edge of the door moves into the gap. However, because of the mechanics of the door, the door itself becomes a lever arm wherein closing the door with only a small force can generate a substantial force at the edge of the door which can crush or break a child's finger located in the gap between the door and the door jamb. Small children are often unaware of the danger and may place their fingers in the gap between the door and the door jamb.

Various finger guards (or door guards, the terms being used interchangeably throughout) are known. However, some of the guards must be specially modified to fit the door or the door casing by placing the guard between the door and the door jamb. Others have some type of protrusion which projects outward when the door is opened or closed. Still others have members that ride or wear against the door, causing damage to the door.

### SUMMARY OF THE INVENTION

The present invention seeks to provide a finger guard for a door. In one preferred embodiment, the finger guard includes a flexible member that may stretch to accommodate an open door, and fold to accommodate the closure of the door, wherein folds at the center of the finger guard protrude farther out and away from the hinge side of the door than the folds at the sides of the finger guard. As the door closes, the central folds of the flexible member tend to push out the fingers or hand of a person, thereby preventing the fingers from being pinched between the door and the door jamb.

Attachment members are provided that are secured to the door and door jamb. The attachment members have receiving portions for receiving therein edge portions of the flexible member. The edge portions may generally freely rotate in the receiving portions when the flexible member moves between the folded and spread configurations. This may prevent wear and tear on the flexible member.

There is thus provided in accordance with an embodiment of the present invention a finger guard including a flexible member including a plurality of folds and two opposite edge portions, the flexible member having a folded configuration and a spread configuration, and a pair of attachment members, one being securable to a door and the other being securable to a door jamb, each of the attachment members including a receiving portion for receiving therein one of the edge portions of the flexible member, wherein folds at a center of the finger guard, called central folds, protrude farther out than folds at sides of the finger guard. The central folds of the flexible member may be wider than the folds at sides of the finger guard.

Each receiving portion may pivotally receive therein one of the edge portions of the flexible member, wherein the edge portions generally freely rotate in the receiving portions when the flexible member moves between the folded and spread configurations. The folds may include convexly rounded knuckles and the edge portions may be convexly rounded. The convexly rounded knuckles and the convexly rounded edge portions may have different diameters. For example, the convexly rounded edge portions may be larger in diameter than the convexly rounded knuckles.

In accordance with an embodiment of the present invention each edge portion may slide into its receiving portion, and a plug may be inserted into the receiving portion to fix the edge portion therein.

### BRIEF DESCRIPTION OF THE DRAWINGS

The present invention will be understood and appreciated more fully from the following detailed description taken in conjunction with the drawings in which:

FIGS. 1 and 2 are simplified top-view sectional illustrations of a finger guard for a door, constructed and operative in accordance with an embodiment of the present invention, in open door and closed door orientations, respectively;

FIG. 3 is a simplified top-view illustration of a flexible member of the finger guard of FIGS. 1 and 2; and

FIG. 4 is a simplified exploded illustration of the finger guard of FIGS. 1 and 2, showing attachment of the flexible member to attachment members, in accordance with an embodiment of the present invention.

### DETAILED DESCRIPTION OF EMBODIMENTS

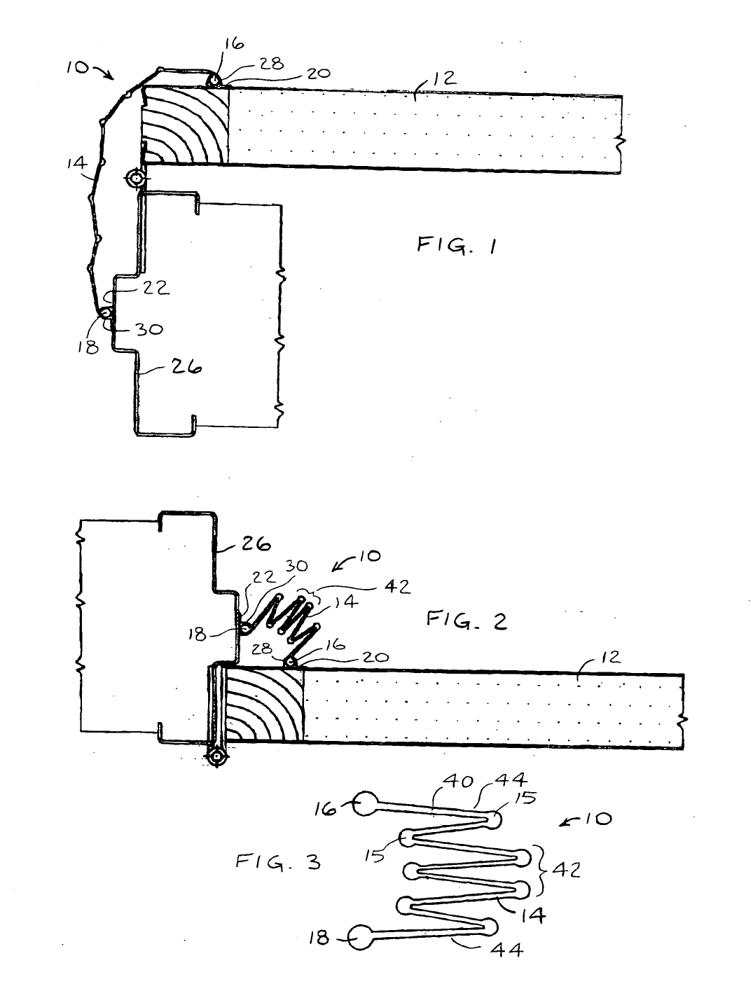

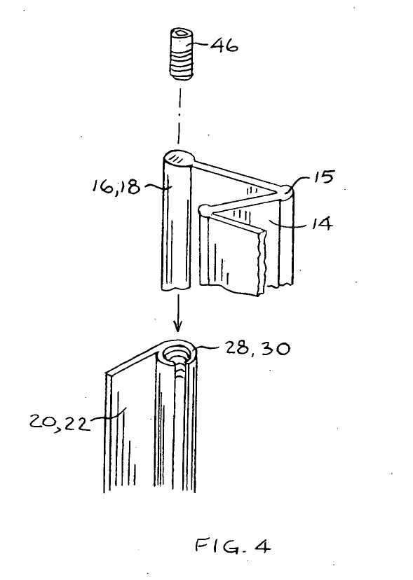

Reference is now made to FIGS. 1 and 3, which illustrate a finger guard 10 for a door 12, constructed and operative in accordance with a preferred embodiment of the present invention.

The finger guard 10 may include a flexible member 14 having two opposite edge portions 16 and 18, respectively. Flexible member 14 may be constructed of an elastomeric material, such as but not limited to, rubber, neoprene, silicone rubber and the like, or a flexible metal sheet, for example.

Flexible member 14 may include a plurality of folds 40 with arcuate knuckles 15 at the joints of the folds. The folds 40 resemble a bellows or accordion, for example. The central folds (i.e., at the center of the finger guard, designated by reference numeral 42) protrude farther out and away from a hinge side 33 of the door 12 than the side folds (i.e., at the sides of the finger guard, designated by reference numeral 44). As the door 12 closes, the central folds 42 of the flexible member 14 tend to push out the fingers or hand of a person, thereby preventing the fingers from being pinched between the door and the doorjamb.

A pair of attachment members 20 and 22 may be secured to door 12 and a door jamb 26, respectively. Attachment members 20 and 22 may be constructed of any sturdy material, such as but not limited to, an aluminum alloy, steel alloy or plastic. Attachment members 20 and 22 may be attached in any suitable manner, such as but not limited to, mechanical fasteners (e.g., screws, nails, rivets, etc.) or adhesive (e.g., adhesive strips, glue, etc.). Since finger guards are often necessary only when children are small, it may be desirable that finger guard 10 be easily removed from the door 12 and door jamb 26 when the children become aware of the dangers of placing their fingers between the door 12 and the jamb 26. In such a case, certain kinds of adhesives may be preferred (e.g., an adhesive that is removable and does not leave marks after removal) or small screws may be preferred.

Attachment members 20 and 22 may comprise receiving portions 28 and 30, respectively, for pivotally receiving therein edge portions 16 and 18, respectively, of flexible member 14. The receiving portions 28 and 30 may be generally concavely rounded in accordance with the shape of edge portions 16 and 18, although, as stated previously, other arbitrary shapes are also within the scope of the invention. As seen best in FIG. 3, in the illustrated embodiment, the convexly rounded knuckles 15 have different diameters than the convexly rounded edge portions 16 and 18. More specifically, the convexly rounded edge portions 16 and 18 are larger in diameter than the convexly rounded knuckles 15.

FIG. 1 illustrates finger guard 10 in a spread configuration with door 12 in an open orientation. The flexible member 14 may stretch to accommodate the open angle of the door 12. FIG. 2 illustrates finger guard 10 in a folded configuration with door 12 in a closed orientation. It is seen that flexible member 14 folds to accommodate the closure of the door 12. Edge portions 16 and 18 generally freely rotate in receiving portions 28 and 30, respectively, when flexible member 14 moves between the folded and spread configurations. Thus, in the present invention, no stress is applied to flexible member 14.

Reference is now made to FIG. 4, which illustrates attachment of the flexible member 14 to attachment members 20 and 22, in accordance with an embodiment of the present invention. Edge portions 16 and 18 may slide into receiving portions 28 and 30, respectively. A plug 46 may be inserted into receiving portion 28 or 30 to fix edge portion 16 or 18 into place. The plug 46 may be threaded (e.g., male or female threads), in which case receiving portion 28 or 30 is complementary threaded (e.g., female or male threads) to accept the threaded plug 46.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

1. A finger guard comprising:
a flexible member including a plurality of folds and two opposite edge portions, said flexible member having a folded configuration and a spread configuration; and
a pair of attachment members, one being securable to a door and the other being securable to a door jamb, each of said attachment members comprising a receiving portion for receiving therein one of said edge portions of said flexible member, wherein folds at a center of the finger guard, called central folds, protrude farther out than folds at sides of the finger guard.

2. The finger guard according to claim 1, wherein the central folds of the flexible member are wider than the folds at sides of the finger guard.

3. The finger guard according to claim 1, wherein each receiving portion pivotally receives therein one of said edge portions of said flexible member, wherein said edge portions generally freely rotate in said receiving portions when said flexible member moves between said folded and spread configurations.

4. The finger guard according to claim 1, wherein said folds comprise convexly rounded knuckles and said edge portions are convexly rounded.

5. The finger guard according to claim 4, wherein the convexly rounded knuckles and the convexly rounded edge portions have different diameters.

6. The finger guard according to claim 4, wherein said convexly rounded edge portions are larger in diameter than said convexly rounded knuckles.

7. The finger guard according to claim 1, wherein each edge portion slides into its receiving portion, and a plug is inserted into the receiving portion to fix the edge portion therein.

8. The finger guard according to claim 7, wherein said plug is threaded and said receiving portion is complementary threaded to accept said plug.

9. A finger guard assembly comprising:
a flexible member including a plurality of folds and two opposite edge portions, said flexible member having a folded configuration and a spread configuration; and
a pair of attachment members, one being secured to a door and the other being secured to a door jamb, each of said attachment members comprising a receiving portion for receiving therein one of said edge portions of said flexible member, wherein folds at a center of the finger guard, called central folds, protrude farther out than folds at sides of the finger guard.

10. The finger guard assembly according to claim 9, wherein each edge portion slides into its receiving portion, and a plug is inserted into the receiving portion to fix the edge portion therein.
